(19) United States
(12) Patent Application Publication
(10) Pub. No.: US 2009/0151402 A1
(43) Pub. Date: Jun. 18, 2009

(54) Combination padlock with a chamber

(75) Inventor: Miko Lee, Hsinchuang City (TW)

Correspondence Address: BACON & THOMAS, PLLC, 625 SLATERS LANE, FOURTH FLOOR, ALEXANDRIA, VA, 22314-1176, US

(73) Assignee: ABA UFO INTERNATIONAL CORP., Hsin Chuang City (TW)

(21) Appl. No.: 12/000,818

(22) Filed: Dec. 18, 2007

(51) Int. Cl. E05B 37/02

(52) U.S. Cl. 70/25

(57) ABSTRACT

A combination padlock has a base, a cover, a lock core assembly and a shackle. The base has a key chamber and a shackle mount. The cover is slidably mounted pivotally on the base to cover the chamber and has a shackle mount. The shackle mount of the cover selectively cooperates with the shackle mount of the base to form a locking recess. The lock core assembly is a combination lock core and is mounted in the base. The shackle combines with the lock core assembly to provide the combination padlock a locking capability and is mounted in the locking recess to prevent the cover sliding relative to the base. Consequently, a user can lock their keys in the chamber and lock the padlock in a preferred place so need not carry the keys everywhere.

### BACKGROUND OF THE INVENTION

1. Field of the Invention

The present invention relates to a combination padlock, and more particularly to a combination padlock with a chamber that protects keys inside by locking the padlock with a combination.

2. Description of the Prior Arts

In some situations, to carry a key is not always convenient for a person. For example, when partaking in exercise or the like, the person may lock money and other valuables in a car or bike but not wish to exercise with the key, merely hiding the key compromises the key's security. While running, jumping or playing sport, holding the key is awkward and may lead to loss of the key.

Many people, especially those with children also leave their house key hidden in case of emergencies. However, many thieves know to look under a mat or in a flowerpot, so a more secure safe place is required.

Shared use doorways or machines such as lawnmowers, garden gates or the like may require a key but all persons with rights of access may not desire to carry a key everywhere, the keys are then frequently lost unless secured nearby.

Finally, many people have key stores on backs of cupboard doors or near entranceways for outside doors, neighbors houses, cars, bicycles or the like. Thieves have been known to break in and steel cars or neighbors keys so a secure device for storage of communal keys is desirable.

For the purpose to prevent this kind of situations, the present invention provides a combination padlock with chamber to mitigate or obviate the aforementioned problems.

### SUMMARY OF THE INVENTION

The primary objective of the present invention is to provide a combination padlock with a chamber that locks keys inside and is able to be locked in a preferred place so a user need not carry keys.

The combination padlock has a base, a cover, a lock core assembly and a shackle. The base has a key chamber and a shackle mount. The cover is slidably mounted rotatably on the base to cover the chamber and has a shackle mount. The shackle mount of the cover selectively cooperates with the shackle mount of the base to form a locking recess. The lock core assembly is a combination lock core and is mounted in the base. The shackle combines with the lock core assembly to provide the combination padlock a locking capability and is mounted in the locking recess to lock combination padlock. Consequently, the lock their keys in the chamber, and lock the padlock in a preferred place so need not carry the keys everywhere.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a combination padlock with a chamber in accordance with the present invention, shown with a cover opened;

FIG. 2 is a partially exploded perspective view of the combination padlock in FIG. 1;

FIG. 3 is an operational perspective view of the combination padlock in FIG. 1, shown with the cover locked shut;

FIGS. 4 and 5 are operational top views in partial section of the combination padlock in FIG. 1;

FIG. 6 is an operational top views in partial section of the combination padlock along line 6-6 in FIG. 7;

FIG. 7 is an operational front view in partial section of the combination padlock with a chamber in FIG. 1, shown being locked; and

FIG. 8 is an operational front view in partial section of the combination padlock with a chamber in FIG. 1, shown having a combination being changed.

### DETAILED DESCRIPTION OF THE PREFERRED EMBODIMENTS

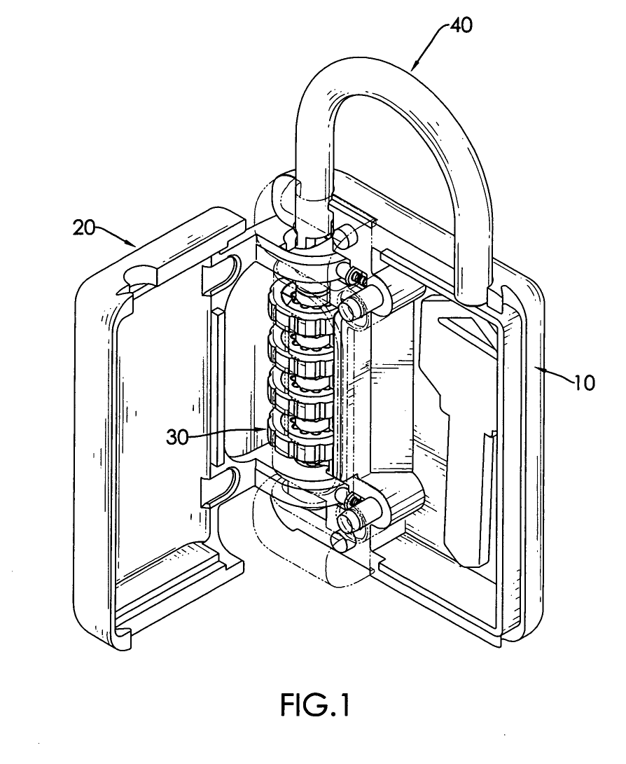

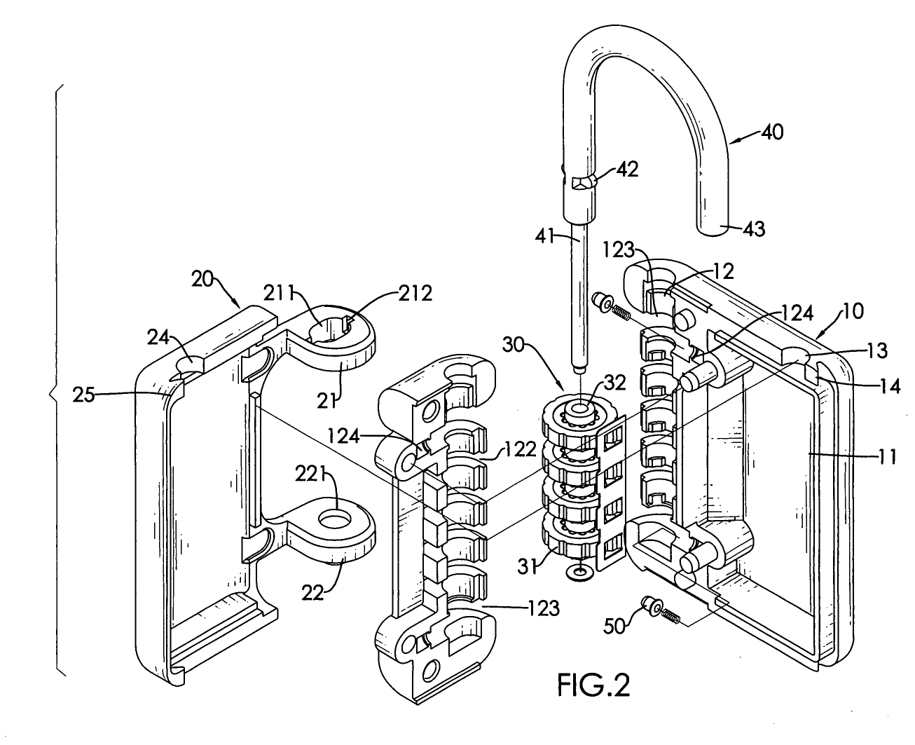

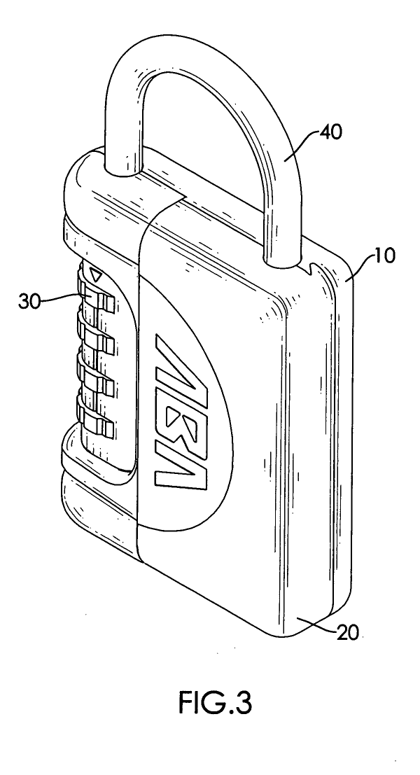

With reference to FIGS. 1 to 3, a combination padlock with a chamber in accordance with the present invention comprises a base (10), a cover (20), a lock core assembly (30), a shackle (40) and two optional pushers (50).

The base (10) has a shackle edge, a mounting edge, a pivoting edge, a locking edge, an inside surface, a key chamber (11), a lock core mount (12) a shackle mount (13) and two locking wedges (14).

The key chamber (11) is formed in the inside surface of the base (10) for mounting keys inside.

The lock core mount (12) is hollow, is formed coaxially through the shackle edge of the base (10) adjacent to the pivoting edge and comprises multiple ring slots (122), two barrel slots (123) and two optional pusher recesses (124). The lock core mount (12) may be partially formed in the base (10) and may have a lock core mount base formed in the base (10) and a lock core mount cover mounted on the lock core mount base.

The ring slots (122) are separately formed through the pivoting edge of the base (10).

The barrel slots (123) are transversely formed through the pivoting edge of the base (10) respectively adjacent to the shackle and mounting edges of the base (10).

The pusher recesses (124) are formed in the lock core mount (12) and respectively adjacent to the barrel slots (123).

The shackle mount (13) is formed in the shackle edge and the inside surface of the base (10) adjacent to the locking edge.

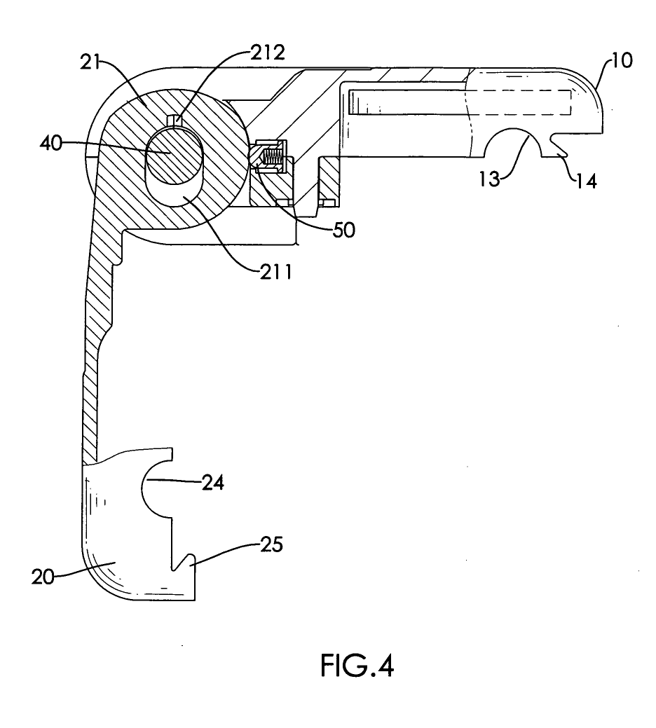

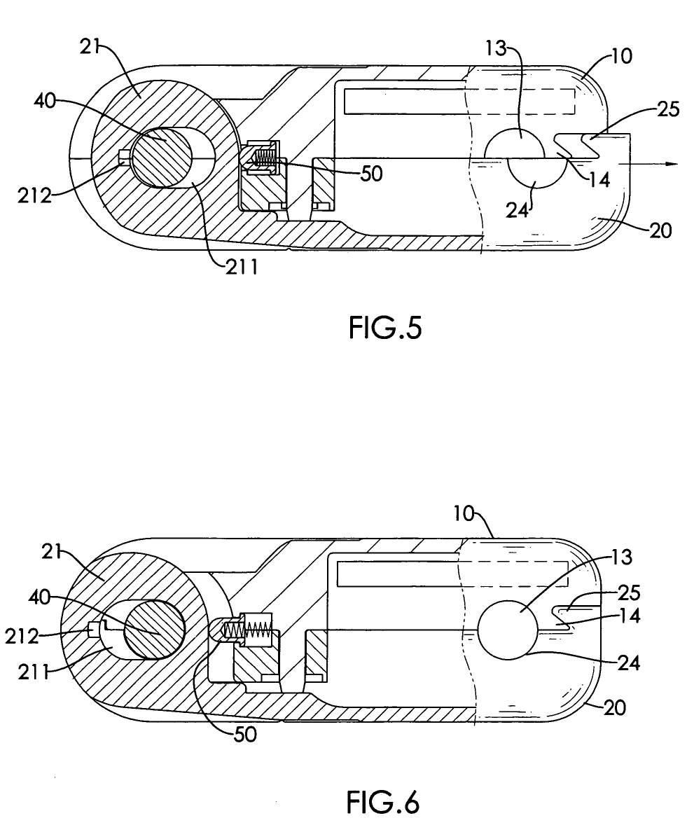

The locking wedges (14) are formed on the inside surface respectively near the shackle and mounting edges of the base (10) and extend toward the locking edge of the base (10) and respectively form two wedge mounts. With further reference to FIGS. 4 to 6, the cover (20) corresponds to and is slidably mounted pivotally on the base (10), and has a shackle edge, a mounting edge, a pivoting edge, a locking edge, an inside surface, a shackle barrels (21), a mounting barrel (22), a shackle mount (24) and two locking wedges (25).

The shackle barrel (21) is formed on and protrudes from the pivoting edge of the cover (20), is slidably mounted pivotally in a corresponding barrel slot (123) to allow the cover (20) to selectively open or close, may be adjacent to a corresponding pusher recess (124) and has an outer surface, an elongated gudgeon (211) and an optional positioning notch (212).

The elongated gudgeon (211) is formed coaxially through the shackle barrel (21), aligns with the lock core mount (12) and has a pivoting side.

The positioning notch (212) is formed in the outer surface of the shackle barrel (21) at the pivoting side of the elongated gudgeon (211).

The mounting barrel (22) is formed on and protrudes from the pivoting edge of the cover (20), is slidably mounted pivotally in a corresponding barrel slot (123) to allow the cover (20) to selectively open or close may be adjacent to a corresponding pusher recess (124) and has an inner surface and an optional locking recess (221).

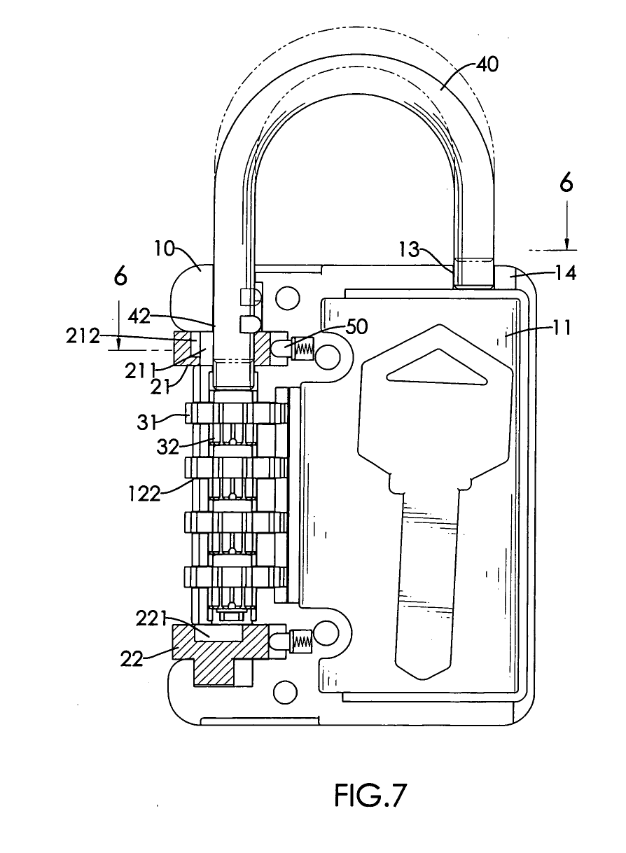

With further reference to FIG. 7, the locking recess (221) is formed in the inner surface of the mounting barrel (22) and corresponds to the lock core mount (12).

The shackle mount (24) of the cover (20) corresponds to the shackle mount (13) of the base (10), is formed in the shackle edge of the cover (10) adjacent to the inside surface and cooperates with the shackle mount (13) of the base (10) to form a locking recess when the cover (20) is closed and locked.

The locking wedges (25) of the cover are respectively formed on the shackle and mounting edges of the cover (20) adjacent to the inside surface, corresponds to and selectively engage the locking wedges (14) of the base (10) to hold the cover (20) on the base (10) when the cover (20) is closed.

The lock core assembly (30) is a combination lock core, is mounted coaxially in the lock core mount (12) and has multiple dial rings (31) and multiple dial cores (32).

The dial rings (31) are rotatably mounted coaxially in a row in the lock core mount (12) between the barrel slots (123), correspond to and protrude out of the ring slots (122) for allowing a user to select numbers for unlocking the combination lock core.

The dial cores (32) are slidably mounted coaxially in and respectively engage the dial rings (31) and each dial core (32) has a through hole. The through hole is formed coaxially through the dial core (32).

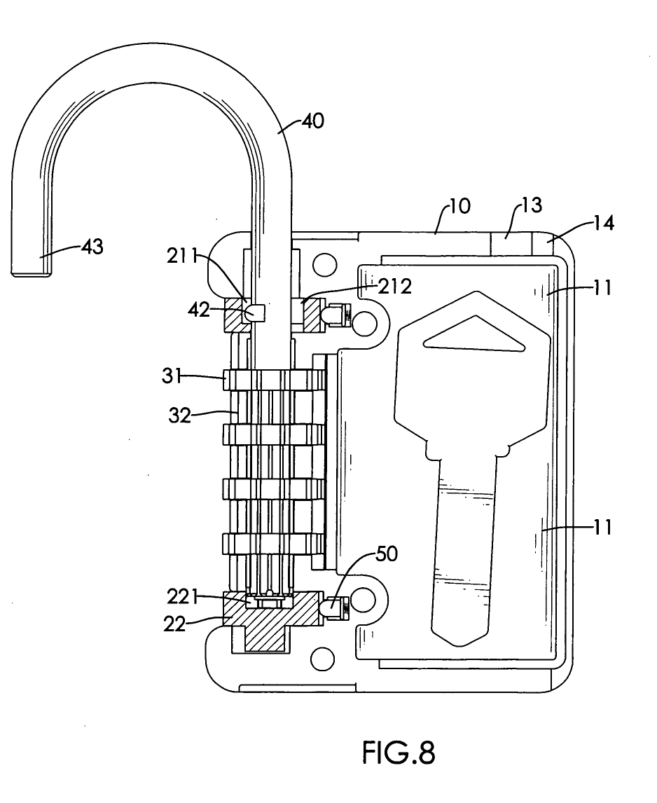

The shackle (40) is substantially U-shaped, is mounted through and combines with the lock core assembly (30) to provide the combination padlock a locking capability, protrudes out of the shackle edge of the base (10), corresponds to and is mounted in the locking recess, selectively locks the cover (20) to the base (10) and has a proximal end (41), a middle, an optional positioning protrusion (42) and a distal end (43). With further reference to FIG. 8, the proximal end (41) is rotatably mounted slidably in the lock core mount (12) and through the elongated gudgeon (211), engages the dial cores (32), selectively corresponds to the locking recess (221) and selectively slides into the locking recess (221) when the cover (20) is closed.

The positioning protrusion (42) is formed on and protrudes perpendicularly from the middle of the shackle (40), corresponds to and is selectively mounted in the positioning notch (212) of the shackle barrel (21) to hold the shackle (40) in position when the user wants to change a combination of the combination padlock with chamber.

The distal end (43) protrudes out of the base (10), corresponds to the locking recess and is mounted securely in the locking recess to prevent the cover (20) and base (10) from sliding relative to one another thereby locking the combination lock with chamber.

The pushers (50) are respectively mounted in the pusher recesses (124) and press against the shackle (40) and mounting barrels (21, 22) to ensure the cover (20) slides relative to the base (10) and locks the combination lock with chamber.

Consequently, the user can put keys (for a car, a room, a machine or the like) inside the combination padlock with the chamber and lock the combination padlock to a preferred place (near the car, the room or the machine and so on). The keys are protected safely in the combination padlock, and the user need not carry the keys.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A combination padlock comprising
a base having
a shackle edge;
a mounting edge;
a pivoting edge;
a locking edge;
an inside surface;
a key chamber being formed in the inside surface of the base;
a lock core mount being formed coaxially through the shackle edge of the base adjacent to the pivoting edge and having
multiple ring slots being separately formed through the pivoting edge of the base; and
two barrel slots being transversely formed through the pivoting edge of the base respectively adjacent to the shackle and mounting edges of the base;
a shackle mount being formed in the shackle edge and the inside surface of the base adjacent to the locking edge; and
two locking wedges being formed on the inside surface respectively near the shackle and mounting edges of the base and extending toward the locking edge of the base;
a cover corresponding to and being slidably mounted pivotally on the base and having
a shackle edge;
a mounting edge;
a pivoting edge;
a locking edge;
an inside surface;
a shackle barrel being formed on and protruding from the pivoting edge of the cover, being slidably mounted pivotally in one of the barrel slots and having
an outside surface; and
an elongated gudgeon being formed coaxially through the shackle barrel, aligning with the lock core mount and having a pivoting side;
a mounting barrel being formed on and protruding from the pivoting edge of the cover, being slidably mounted pivotally in a corresponding barrel slot, being selectively slidable relative to the base and having an inner surface;
a shackle mount corresponding to the shackle mount of the base, being formed in the shackle edge of the cover adjacent to the inside surface and selective cooperating with the shackle mount of the base to form a locking recess; and
two locking wedges being respectively formed on the shackle and mounting edges of the cover adjacent to the inside surface, corresponding to selectively engaging the locking wedges of the base;
a lock core assembly being mounted coaxially correspondingly in the lock core mount and having
multiple dial rings being rotatably mounted coaxially in a row in the lock core mount between the barrel slots, corresponding to and protruding out of the ring slots; and
multiple dial cores being slidably mounted coaxially in and respectively engaging the dial rings and each dial core having a through hole being formed coaxially through the dial core; and
a shackle being substantially U-shaped, being mounted through and combining with the lock core assembly, protruding out of the shackle edge of the base, corresponding to and being mounted in the locking recess, selectively locks the cover to the base and having
a proximal end being rotatably mounted slidably in the lock core mount, through the elongated gudgeon and engaging the dial cores;
a middle; and
a distal end protruding out of the base and corresponding to and being selectively mounted securely in the locking recess.

2. The combination padlock as claimed in claim 1, wherein
the base further has two pusher recesses being formed in the lock core mount respectively adjacent to the barrel slots and being adjacent to the shackle and mounting barrels; and
the combination padlock further has two pushers being respectively mounted in the pusher recesses and pressing against the shackle and mounting barrels.

3. The combination padlock as claimed in claim 2, wherein
the shackle barrel further has an positioning notch being formed in the outer surface of the shackle barrel at the pivoting side of the elongated gudgeon; and
the shackle further has a positioning protrusion being formed on and protruding perpendicularly from the middle of the shackle, corresponding to and being selectively mounted in the positioning notch of the shackle barrel.

4. The combination padlock with chamber as claimed in claim 3, wherein
the mounting barrel further has a locking recess being formed in the top of the inner surface of the mounting barrel and aligning with the lock core mount; and
the proximal end of the shackle corresponds to the locking recess and selectively slides into the locking recess.

5. The combination padlock with chamber as claimed in claim 4, wherein the lock core mount of the base further comprises a lock core mount base formed in the base and a lock core mount cover mounted on the lock core mount base.
